(19) United States
(12) Patent Application Publication
(10) Pub. No.: US 2025/0247270 A1
(43) Pub. Date: Jul. 31, 2025

(54) SYSTEMS, APPARATUS, AND METHODS TO ENABLE DUAL VIRTUAL PRIVATE NETWORK CONNECTIVITY

(71) Applicant: The Boeing Company, Arlington, VA (US)

(72) Inventor: Christopher Sheridan Vanik, Titusville, FL (US)

(21) Appl. No.: 18/422,825

(22) Filed: Jan. 25, 2024

(51) Int. Cl. H04L 12/46

(52) U.S. Cl. CPC H04L 12/4641; H04L 12/4633

(57) ABSTRACT

Systems, apparatus, and methods to provide dual virtual private network connectivity are disclosed herein. An example system includes a mobile hardware virtual private network (VPN) device, the mobile hardware VPN device communicatively coupled to an end device, the mobile hardware VPN device to establish a first VPN tunnel to encrypt data generated by a second VPN tunnel associated with the end device; and a transceiver communicatively coupled to the mobile hardware VPN device, the transceiver to communicate with a secure network via a wireless communication protocol to cause a VPN server to permit the end device to exchange data with the secure network via the first VPN tunnel and the second VPN tunnel.

### FIELD OF THE DISCLOSURE

This disclosure relates generally to network security and, more particularly, to systems, apparatus, and methods to enable dual virtual private network connectivity.

### BACKGROUND

Some computing architectures that control access to data stored in a secure network rely on the use of dual, nested virtual private network (VPN) tunnels to authenticate an end device requesting access to such data. For instance, the Commercial Solutions for Classified (CSfC) architecture developed by the National Security Administration (NSA) controls access to data using a protocol based on dual, nested VPN tunnels. However, some end devices, such as mobile devices, may not support multiple VPN tunnels concurrently.

### SUMMARY

An example system includes a mobile hardware virtual private network (VPN) device, the mobile hardware VPN device communicatively coupled to an end device, the mobile hardware VPN device to establish a first VPN tunnel to encrypt data generated by a second VPN tunnel associated with the end device; and a transceiver communicatively coupled to the mobile hardware VPN device, the transceiver to communicate with a secure network via a wireless communication protocol to cause a VPN server to permit the end device to exchange data with the secure network via the first VPN tunnel and the second VPN tunnel.

An example method includes communicatively coupling an end device to a mobile hardware virtual private network (VPN) device; and communicatively coupling the mobile hardware VPN device to a wireless communication-based transceiver to enable communication between the end device and a secure network based on a wireless communication protocol.

Another example method includes generating, via an end device, a first encrypted data via a first virtual private network (VPN) tunnel; generating, via a mobile hardware VPN device, second encrypted data via a second VPN tunnel, the second encrypted data including the first encrypted data; transmitting the second encrypted data to a transceiver; and transmitting, by the transceiver and via a wireless communication protocol, the second encrypted data to a secure network for decryption of the first encrypted data and the second encrypted data.

### BRIEF DESCRIPTION OF THE DRAWINGS

FIG. 1 is a block diagram of an example system including a hardware virtual private network (VPN) device for providing dual VPN tunnel capability to an end device for accessing a secure network.

FIG. 2 is a schematic diagram illustrating execution of a dual VPN tunnel protocol between the example end device and the secure network of FIG. 1 to enable exchange of data.

FIG. 3 is a flowchart of an example method to assemble the system of FIG. 1.

FIG. 4 is a flowchart representative of example machine-readable instructions and/or example operations that may be executed, instantiated, and/or performed by example programmable circuitry to implement the dual VPN tunnel protocol of FIG. 2.

FIG. 5 is a flowchart representative of example machine-readable instructions and/or example operations that may be executed, instantiated, and/or performed by example programmable circuitry of a secure network to authenticate an end device using the dual VPN tunnel protocol of FIG. 2.

FIG. 6 is a block diagram of an example processing platform including programmable circuitry structured to execute, instantiate, and/or perform the example machine-readable instructions and/or perform the example operations of FIG. 4 to implement VPN tunnel circuitry of the end device of FIG. 1.

FIG. 7 is a block diagram of an example processing platform including programmable circuitry structured to execute, instantiate, and/or perform the example machine-readable instructions and/or perform the example operations of FIG. 4 to implement VPN tunnel circuitry of the hardware VPN device of FIG. 1.

In general, the same reference numbers will be used throughout the drawing(s) and accompanying written description to refer to the same or like parts. The figures are not necessarily to scale.

### DETAILED DESCRIPTION

Some computing architectures that control access to data stored in a secure network rely on the use of dual, nested virtual private network (VPN) tunnels to authenticate an end device requesting access to such data. In a dual, nested VPN tunnel configuration, an outer VPN tunnel and an inner VPN tunnel are established. Data flowing through the inner VPN tunnel is encrypted and, because the same data flows through the outer tunnel, the data becomes twice-encrypted data. The encrypted layers of data are decrypted by respective VPN servers to provide secure connectivity between the end device and a network for the exchange of data.

For instance, the Commercial Solutions for Classified (CSfC) architecture developed by the National Security Administration (NSA) controls access to data using a protocol based on dual, nested VPN tunnels. In particular, the CSfC architecture incorporates the use of commercially available devices that can be used to create a secure data pipeline for data over untrusted networks while addressing concerns such as supply chain issues and cost. For example, the commercially available end devices can be used to connect to multiple layers of a network infrastructure via the dual VPN tunnels before receiving access to the data. To access a secure network, communication can be established with a first network (referred to as a “black network” by the NSA's CSfC program). The first network can be an untrusted network in that the network is owned by a third party. For example, the first network can include a cellular network. Thus, the data passing through the untrusted network should include two layers of encryption. After passing through a VPN gateway (e.g., an outer VPN gateway server), a second network (referred to as a “gray network” by the NSA's CSfC program) is accessible. The second network is part of the secure network access infrastructure (i.e., the second network is a trusted network) and data passing through the second network should include one layer encryption for security purposes. A third network (referred to as a “red network” by the NSA's CSfC program) is accessible after passing through another VPN gateway; the third network (i.e., the secure network) includes the unencrypted data.

However, some end devices such as mobile devices (e.g., smartphones, electronic tablets, mixed reality headsets or other wearable electronic devices) may not support multiple VPN tunnels natively or off-the shelf (e.g., without custom code, modification, etc.). Rather, such devices may lack the computing, battery, and/or network resources to implement multiple nested VPN tunnels. As such, some end devices are not able to connect to secure networks that use dual, nested VPN tunnel protocols for device authentication, despite these devices being readily commercially available and offering benefits such as portability and low power consumption.

Some known efforts to connect end devices to a secure network include the use of hardware VPN devices. Known systems and methods for establishing communication between an end device and an outer VPN gateway rely on wireless communication protocols. For instance, end device(s) can be connected via a wired connection (e.g., Ethernet) to a hardware VPN device. The hardware VPN device uses, for instance, a Wi-Fi radio to communicate traffic wirelessly to the first network (e.g., the “black network” of the NSA's CSfC program, the untrusted network). In some instances, the end device(s) are connected to the hardware VPN device via Wi-Fi and the hardware VPN device includes an output port (e.g., an Ethernet port) to establish communication with the first or untrusted network via a wired connection.

However, in some secure, closed, or otherwise classified environments such as manufacturing plants, factories, warehouses, or other environments where security sensitive work is performed, use of Wi-Fi is prohibited because of security concerns. Such environments may permit use of other communication protocols (e.g., controllable or managed communication protocols), such as 5G cellular communication protocols, which provide for higher security, faster speeds, etc. Thus, in some instances, the use of Wi-Fi to connect to a secure network is not available.

Disclosed herein are example systems, apparatus, and methods for providing dual, nested VPN tunnels to enable an end device that supports one VPN tunnel (e.g., natively supports only one VPN tunnel) to exchange data with a secure network. Examples disclosed herein can enable such access to the secure network using communication protocols other than Wi-Fi. In examples disclosed herein, a mobile hardware VPN device can be communicatively coupled to an end device (e.g., an electronic headset, a smartphone). A first (e.g., outer) VPN tunnel connection is established by the mobile hardware VPN device. A second (e.g., inner) VPN tunnel connection is established through the end device. In examples disclosed herein, rather than communicating via Wi-Fi, the mobile hardware VPN device is communicatively coupled to a transceiver that supports communication protocols other than Wi-Fi, such as 3GPP protocols (e.g., 5G protocols) or radio frequency (RF) protocols. The transceiver communicates with a first network (e.g., an untrusted network) via, for instance, 5G communication. The first network communicates with a VPN gateway of a secure access network infrastructure that provides access to the secure network. As such, twice encrypted data generated by the two VPN tunnels (i.e., the first/outer VPN tunnel connection established through the mobile hardware VPN device and the second/inner VPN tunnel established through the end device) is provided to access the secure network. Components of the secure network access infrastructure (e.g., firewalls, VPN servers acting as gateway) perform protocols such as decryption and verification of the data received from the end device to verify that the end device is authorized to access the data stored at the secure network.

Thus, examples disclosed herein enable an end device that supports one VPN tunnel to access a secure network that relies on dual, nested VPN tunneling. Further, examples disclosed herein provide a mobile solution to establish network connectivity by using portable devices, such as a mobile hardware VPN device, a portable transceiver, and portable power source(s). Thus, examples disclosed herein can be readily implemented in environments such as factories or warehouses (e.g., warehouses with high volume traffic and configurable workspaces).

Although examples disclosed herein are discussed in connection with access to secured data and refer to the NSA's CSfC program, examples disclosed herein are not limited to such uses and/or architectures. Rather, examples disclosed herein can be used to provide Transmission Control Protocol/Internet Protocol (TCP/IP)-based end devices that operate on various networks, platforms, or operating systems with dual VPN tunnel connection capabilities. Thus, in examples disclosed herein, end devices without specialized network security features can become compatible network devices.

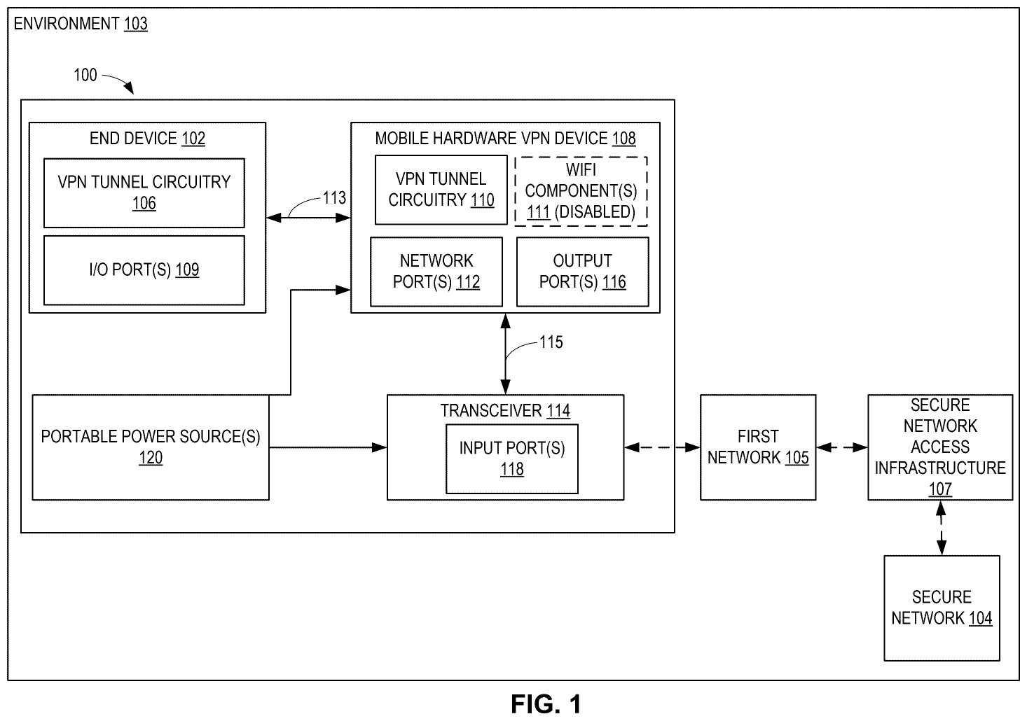

FIG. 1 is a block diagram of an example system 100 for providing dual, nested VPN connectivity between an end device 102 and a secure network 104. The end device 102 can be, for example, a mobile device (e.g., a smartphone), a personal computing device (e.g., a laptop, an electronic table), a wearable electronic device (e.g., a head mounted electronic device such as a virtual reality/augmented reality/mixed reality headset). The end device 102 can include other types of devices, such as robots, laser tracking & measurement systems, sensor arrays, automated guided vehicles, factory automation devices, industrial equipment (e.g., for use in the aerospace industry), etc. The example end device 102 complies with Transmission Control Protocol/Internet Protocol (TCP/IP) standards. The end device 102 may be located in a security restricted environment 103, such as environment in which the use of Wi-Fi is prohibited. The secure network 104 can store protected data that a user may wish to access via the end device 102 while located in the environment 103.

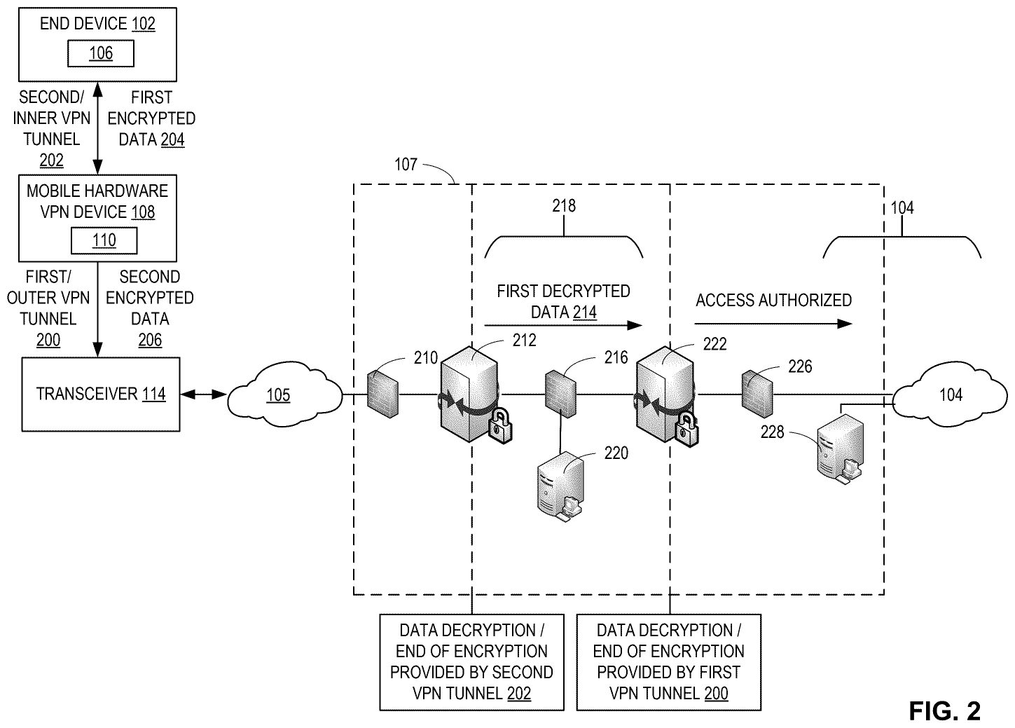

In the example of FIG. 1, access to the secure network 104 is established via communication with a first network 105 and a secure network access infrastructure 107. The first network 105 (e.g., referred to as a “black network” by the NSA's CSfC program) can be, for example, a 3GPP or radio frequency (RF) communication network. In some examples, the first network 105 is controlled by an owner of the secure network 104; in such instances the first network 105 is a trusted network. In other examples, the first network is controlled by a different party than the party that controls the secure network 104. In such instances the first network 105 is an untrusted network. As disclosed herein (FIG. 2), the secure network access infrastructure 107 includes components such as firewalls, VPN servers, etc. that control or regulate access to the secure network 104.

The example end device 102 includes VPN client circuitry 106 (e.g., a VPN client) to establish a VPN tunnel connection with a VPN server (i.e., an encrypted connection between the end device 102 and a VPN server, such as a VPN server (FIG. 2) of the secure network access infrastructure 107). The VPN client circuitry 106 of the end device 102 may be implemented by, for example, hardware, software, and/or firmware of the end device 102 (e.g., programmable circuitry of the end device 102). To establish the VPN connection, the VPN client circuitry 106 of the end device 102 initiates a request to connect with the VPN server. The VPN client circuitry 106 includes pre-shared keys (e.g., certificates/credentials). The VPN server determines, based on the credentials provided by the VPN client circuitry 106, whether or not the end device 102 is permitted to establish the VPN connection with the VPN server. When the VPN server approves the request (e.g., based on authentication of user credentials), the VPN server provides the VPN client circuitry 106 with local area network details such as an Internet protocol (IP) address, network time, etc. The exchange between the VPN server and the VPN client circuitry 106 establishes a VPN tunnel between the VPN client circuitry 106 and the VPN server. The VPN client circuitry 106 of the end device 102 generates an encrypted data stream that is transmitted via the VPN tunnel. The encrypted data can include encrypted network traffic data including IP data. In examples in which the VPN server determines that the credentials provided by the VPN client circuitry 106 are not valid, the VPN server terminates the connection with the VPN client circuitry 106.

In examples disclosed herein, the terms “encrypt” or “encryption” refer to changing or converting information (e.g., electronic data, signals) into a secret code (e.g., defined by letters, numbers, symbols) that cannot be understood or used (e.g., read, processed) without returning the information to its original form (or another usable form). Some examples disclosed use encryption standards that are part of the Internet Protocol Security suite, such as Internet Key Exchange (IKE) encryption protocols (e.g., IKE V1 or IKE V2). In some examples, Advanced Encryption Standard (AES) 256 is used by the IKE. In examples disclosed herein, the encrypted data can be transformed, changed, or returned its original form (or other usable form) via decryption processes such as decoding, unscrambling, deciphering, any of which may involve the use of special equipment, possession of a key (encryption key), etc. to reverse the encryption. Examples disclosed herein can use past, present, or future encryption or decryption protocols.

As disclosed herein, the VPN client circuitry 106 of the end device 102 establishes a VPN tunnel connection with a VPN server of the secure network access infrastructure 107. The VPN tunnel established between the VPN client circuitry 106 and the VPN server of the secure network access infrastructure 107 can be, for example, an Internet Protocol Security (IPSec) Internet Key Exchange (IKE) VPN tunnel (e.g., IPSec IKE v1 or IKE v2), or a Transport Layer Security (TLS) VPN tunnel. In examples disclosed herein, the VPN tunnel established between the VPN client circuitry 106 of the end device 102 and the VPN server of the secure network access infrastructure 107 defines one of two VPN tunnels that are established to enable the end device 102 to exchange data with the secure network 104.

In the example of FIG. 1, the secure network 104 requires the use of dual, nested VPN tunnels to permit access to the data stored on the secure network 104. In the example of FIG. 1, the end device 102 supports one VPN tunnel established through the VPN client circuitry 106 of the end device 102. However, the end device 102 may not support concurrent use of multiple VPN tunnels. Further, as mentioned above, the use of Wi-Fi may be prohibited in the environment 103 in which the end device 102 is operating due to security concerns. Instead, use of wireless communication protocols such as 3GPP (e.g., 5G) cellular communications or RF communications may be permitted in the environment 103.

To provide dual, nested VPN tunnel capability to the end device 102, the example system 100 of FIG. 1 includes a portable or mobile hardware VPN device 108 (also referred to as a mobile encrypter device). The mobile hardware VPN device 108 includes VPN client circuitry 110 (e.g., a VPN client). The VPN client circuitry 110 of the mobile hardware VPN device 108 may be implemented by software, hardware, and/or firmware of the mobile hardware VPN device 108 (e.g., programmable circuitry of the mobile hardware VPN device 108). In operation, the VPN client circuitry 110 can be used to establish a VPN tunnel connection between an end device communicatively coupled to the mobile hardware VPN device 108 and a network.

In the example of FIG. 1, the VPN client circuitry 110 of the mobile hardware VPN device 108 establishes a VPN tunnel connection (e.g., a first or outer VPN tunnel connection) between the mobile hardware VPN device 108 and a VPN server of the secure network access infrastructure 107 (e.g., a first VPN server 212 of the secure network access infrastructure 107 of FIG. 2). Also, as discussed above, the VPN client circuitry 106 of the end device 102 establishes a VPN tunnel connection (e.g., a second or inner VPN tunnel connection) with another VPN server of the secure network access infrastructure 107 (e.g., a second VPN server 222 of the secure network access infrastructure 107 of FIG. 2). Put another way, the VPN client circuitry 110 of the mobile hardware VPN device 108 establishes a VPN tunnel connection such that the secure network access infrastructure 107 recognizes the end device 102 as providing dual, nested VPN tunnels for connection to the secure network 104, namely (a) the first (outer) VPN tunnel connection established between mobile hardware VPN device 108 and the first VPN server of the secure network access infrastructure 107 and (b) the second (inner) VPN tunnel connection established between the VPN client circuitry 106 of the end device 102 and the second VPN server of the secure network access infrastructure 107). As a result, the secure network access infrastructure 107 recognizes the end device 102 as satisfying or compatible with the network connectivity criteria.

The second tunnel established through the VPN client circuitry 110 of the mobile hardware VPN device 108 can be an Internet Protocol Security (IPSec) Internet Key Exchange (IKE) VPN tunnel (e.g., IPSec IKE v1 or IKE v2). The second VPN tunnel can be established between the VPN client circuitry 110 of the mobile hardware VPN device 108 and the VPN server of the secure network access infrastructure 107 based on authentication of credentials/certificates provided by the VPN client circuitry 110 and verified by the VPN server (e.g., substantially as disclosed in connection with the VPN client circuitry 106 of the end device 102).

In the example of FIG. 1, the mobile hardware VPN device 108 receives encrypted data generated by the VPN client circuitry 106 of the end device 102 that is to be transmitted to the secure network 104. The VPN client circuitry 110 of the mobile hardware VPN device 108 encapsulates and encrypts the data stream to generate twice-encrypted data. Thus, the data stream generated by the end device 102 has multiple layers of encryption before being transmitted (e.g., wirelessly transmitted) through the first (e.g., untrusted) network 105 that is in communication with the secure network 104 via the secure network access infrastructure 107.

The mobile hardware VPN device 108 can include Wi-Fi component(s) 111 (e.g., Wi-Fi antenna(s), radios, etc.) to establish wireless communication between (a) an end device and the mobile hardware VPN device 108 and/or (b) the mobile hardware VPN device 108 and a VPN server. However, as mentioned above, in the environment 103 in which the end device 102 is attempting to access the secure network 104, wireless communication protocols such as Wi-Fi are not permitted due to security concerns. Thus, the use of Wi-Fi to establish a connection between the end device 102 and the secure network 104 via the mobile hardware VPN device 108 would not be effective in the example environment 103.

The example mobile hardware VPN device 108 of FIG. 1 includes one or more network ports 112 (e.g., LAN port(s), ethernet port(s)). In the example of FIG. 1, the end device 102 is communicatively coupled to the mobile hardware VPN device 108 via one of the network ports 112, as represented by arrow 113 in FIG. 1. For example, an input/output (I/O) port 109 of the end device 102 can be communicatively coupled to one of the LAN ports 112 of the mobile hardware VPN device 108 via a serial communication protocol, such as a USB-C cable coupled to an ethernet adapter, which is then coupled to an ethernet cable (e.g., a CAT5 ethernet cable). The ethernet cable is received by the LAN IN port 112 of the mobile hardware VPN device 108. In examples in which the I/O port(s) 109 of the end device 102 include an ethernet port, an ethernet cable can be used to communicatively couple to the end device 102 and the mobile hardware VPN device 108 (i.e., without the use of the USB cable and the ethernet adapter). Other types of cable(s) can be used to provide for a (e.g., wired) connection between the devices 102, 108 based on the I/O port(s) 109 of the end device 102 and/or the LAN port(s) 112 of the mobile hardware VPN device 108.

In the example of FIG. 1, the wireless communication capabilities of the mobile hardware VPN device 108 are disabled (e.g., in view of the prohibition of Wi-Fi in the environment 103). For example, the Wi-Fi antenna(s) 111 of the mobile hardware VPN device 108 are disabled (e.g., disabled in BIOS/firmware from operating) and/or removed from the device 108. However, because the ethernet cable (e.g., CAT5 cable) from the end device 102 is received in the LAN IN port 112 of the mobile hardware VPN device 108, the mobile hardware VPN device 108 continues to operate to passthrough data via a VPN tunnel established by the mobile hardware VPN device 108.

In some examples, the end device 102 also includes Wi-Fi component(s) (e.g., Wi-Fi antenna(s), radios, etc.). In examples disclosed herein, the Wi-Fi component(s) of the end device 102 can also be disabled (e.g., disabled in BIOS/firmware from operating) or removed. Also, additional/extra unused ports on the mobile hardware VPN device 108 or the end device 102 can be physically blocked using a port blocker or disabled or otherwise destroyed from being usable for additional security.

In the example of FIG. 1, the mobile hardware VPN device 108 is communicatively coupled to a transceiver 114, as represented by arrow 115 in FIG. 1. The example transceiver 114 of FIG. 1 provides for 3GPP-based (e.g., 5G cellular) or RF-based communication with network infrastructure components of the secure network access infrastructure 107. For example, an output port 116 of the mobile hardware VPN device 108 can be communicatively coupled to an input port 118 of the transceiver 114 via serial communication protocols (e.g., one or more cables such as a USB-A to USB-C cable) to provide for a (e.g., wired) connection between the devices 108, 114. Although example disclosed herein refer to 3GPP (e.g., 5G cellular) and/or RF communications with respect to the transceiver 114, other past, current, and/or future communication protocols (e.g., wired communication protocols, wireless communication protocols, cellular communication protocols, etc.) can be used to establish communication between the transceiver 114 and the secure network 104.

In some examples, the end device 102 includes and/or otherwise carries the transceiver 114. Also, in some examples, the system 100 includes one or more portable power sources 120 (e.g., a portable battery) to provide power to the mobile hardware VPN device 108, the transceiver 114, and/or the end device 102.

The example transceiver 114 (e.g., a 5G transceiver) of FIG. 1 communicates with the first network 105 (e.g., an untrusted network operating on 5G protocols) to establish communication with the infrastructure component(s) (e.g., VPN servers) of the secure network access infrastructure 107. In some examples, a cellular base station/radio authenticates the transceiver 114 (e.g., based on an approved data, checking that for instance, a SIM card of the transceiver 114 is allowed to access the cellular network). Such authentication prevents, for example, unauthorized devices from accessing the (outer) VPN server of the secure network access infrastructure 107.

As disclosed herein (FIG. 2), the encrypted data generated by the mobile hardware VPN device 108 (i.e., the two-layer encrypted data stream) is transmitted via the transceiver 114 and the outer VPN tunnel established between the mobile hardware VPN device 108 and a VPN server at a first gateway to the secure network 104. The data carried by the second VPN tunnel is decrypted by the VPN server of the first gateway. In particular, the VPN server of the first gateway decrypts the layer of encryption generated by the second VPN tunnel associated with the mobile hardware VPN device 108. The once-decrypted data is transmitted to a VPN server of a second gateway, which decrypts the layer of encryption provided by the inner VPN tunnel established between the end device 102 and the VPN server of the second gateway. Because of the two layers of encryption provided by the two VPN tunnels, the secure network access infrastructure 107 permits the end device 102 to exchange data with the secure network 104.

Thus, the example system 100 of FIG. 1 provides the end device 102, which natively supports one VPN tunnel, with dual, nested VPN tunnel capability. Further, the example system 100 of FIG. 1 provides for alternative communication protocols when Wi-Fi is not available in the environment 103. However, although examples disclosed herein are discussed in connection with communication protocols other than Wi-Fi, in some examples, the system 100 of FIG. 1 can provide for dual VPN capabilities over Wi-Fi. For example, the mobile hardware VPN device 108 can provide a second VPN tunnel for the end device 102 and communicate with a VPN server via Wi-Fi in environments where such communication is permitted. Further, the use of the portable power source(s) 120 to power the mobile hardware VPN device 108 and/or the transceiver 114 can increase portability of the example system 100 to provide dual VPN tunnel capabilities in a variety of environments.

FIG. 2 is a schematic diagram illustrating execution of a dual, nested VPN protocol between the end device 102 and the secure network 104 of FIG. 1 to enable exchange of data between the end device 102 and the secure network 104. As shown in FIG. 2, the secure network 104 is associated with the secure network access infrastructure 107, which includes components such as firewalls, VPN gateways, etc. that control access to the data stored at the secure network 104. As disclosed herein, the VPN client circuitry 110 of the mobile hardware VPN device 108 requests to establish a first or outer VPN tunnel 200 with a first VPN server 212 of the secure network access infrastructure 107. Also, the VPN client circuitry 106 of the end device 102 requests to establish a second or inner VPN tunnel 202 with a second VPN server 222 of the secure network access infrastructure 107.

As disclosed in connection with FIG. 1, the mobile hardware VPN device 108 is communicatively coupled to the transceiver 114 (e.g., a 3GPP transceiver). The transceiver 114 establishes communication with the secure network 104 via the first network 105 (referred to as a “black network” by the National Security Administration's Commercial Solutions for Classified (CSfC) program). The first network 105 can include, for instance, a privately owned 3GPP (e.g., 5G) cellular or radio frequency (RF) network. In some examples, the first network 105 may be controlled by an untrusted party. In other examples, the first network 105 is controlled by an owner of the secure network 104 and, thus, is a trusted network that can be considered part of the secure network access infrastructure 107. The first network 105 can define a first layer or outer gateway network for accessing the secure network 104. In the example of FIG. 2, the transceiver 114 establishes communication with the first network 105 via an authentication protocol.

In the example of FIG. 2, the VPN client circuitry 110 of the mobile hardware VPN device 108 sends a VPN connection request to the first VPN server 212 of the secure network access infrastructure 107 via the transceiver 114 and the first network 105. The first VPN server 212 serves as an outer encryption VPN boundary or gateway for permitting access to a second network 218 of the secure network access infrastructure 107 (e.g., the second network 218 is referred to as a “gray network” by the National Security Administration's Commercial Solutions for Classified (CSfC) program). The first VPN server 212 confirms that the mobile hardware VPN device 108 is authorized to establish a VPN connection with the first VPN server 212 of the secure network access infrastructure 107. For example, the secure network access infrastructure 107 includes network management service infrastructure component(s) 220 that can, for example, perform authentication services. The first VPN server 212 can authenticate the mobile hardware VPN device 108 based on the authentication performed by the network management service infrastructure component(s) 220. After the first VPN server 212 verifies the mobile hardware VPN device 108, the first or outer VPN tunnel 200 (e.g., IPSec IKE v1 or IKE v2 VPN tunnel) is established between the VPN client circuitry 110 of the mobile hardware VPN device 108 and the first VPN server 212.

In the example of FIG. 2, the VPN client circuitry 106 of the end device 102 sends a VPN connection request to the second VPN server 222 of the secure network access infrastructure 107 via the transceiver 114 and the first network 105. The second VPN server 222 serves as an inner encryption VPN boundary or gateway for permitting access to the secure network 104 where unencrypted data is stored (e.g., the secure network 104 is referred to as a “red network” by the National Security Administration's Commercial Solutions for Classified (CSfC) program). The second VPN server 222 confirms that the end device 102 is authorized to establish a VPN connection to access the secure network 104. For example, the second VPN server 222 can verify the end device 102 based on authentication services performed by network management service infrastructure component(s) 228 of the example secure network access infrastructure 107. After the second VPN server 222 verifies the end device 102, the second or inner VPN tunnel 202 (e.g., IPSec IKE v1 or IKE v2 VPN tunnel) is established between the VPN client circuitry 106 of the end device 102 and the second VPN server 222.

The end device 102 generates data for transmission to the secure network 104 (e.g., requests, messages, a web browser, video stream, word processing documents, spreadsheets, CAD models, PDF files, and/or other types of data passed via TCP/IP protocol). The VPN client circuitry 106 of the end device 102 encrypts the data to generate first encrypted data 204 (e.g., via encryption, encapsulation, etc.). The first encrypted data 204 has one layer of encryption. The first encrypted data 204 is transmitted (e.g., via the wired connection between the end device 102 and the mobile hardware VPN device 108). The VPN client circuitry 110 of the mobile hardware VPN device 108 encrypts the first encrypted data 204 to generate second encrypted data 206. Thus, the second encrypted data 206 includes the first encrypted data 204 with an additional layer of encryption (i.e., the second encrypted data 206 is twice encrypted data).

The second encrypted data 206 passes through the first or outer VPN tunnel 200 to the first VPN server 212 via the first (e.g., untrusted) network 105. Thus, the two layers of encryption in the second encrypted data 206 provide protection of the data when the first network 105 is an untrusted network. Also, in the example of FIG. 2, the second encrypted data 206 passes through an outer firewall 210 to a first VPN server 212. The outer firewall 210 is included in the secure network access infrastructure 107. The outer firewall 210 allows incoming data, such as incoming IPSec data. For example, the outer firewall 210 filters IP packet traffic to allow, tag, and route specific data streams to specific ports.

The first VPN server 212, or an outer VPN gateway, performs a decryption operation on the second encrypted data 206 to remove the layer of encryption provided by the first or outer VPN tunnel 200. As result of the decryption by the first VPN server 212, first decrypted data 214 is revealed. The first decrypted data 214 corresponds to the first encrypted data 204 (i.e., once-encrypted data) generated by the end device 102. Thus, when the second encrypted data 206 is decrypted by the first VPN server 212, the encryption provided by the first VPN tunnel 200 associated with the mobile hardware VPN device 108 ends.

The first decrypted data 214 passes through a second firewall 216. In the example of FIG. 2, the second firewall 216 is associated with the second network 218 of the secure network access infrastructure 107. Because the second network 218 is a trusted network (i.e., controlled by the owner of the secure network 104), data with one layer of encryption is permitted to pass through the second network 218. The second firewall 216 can be a demilitarized firewall that serves as an intermediary or sub-network to reduce the risk of unauthorized access by, for example, filtering data traffic. Also, the second network 218 includes the network management service infrastructure component(s) 220 that can, for example, manage encryption keys, manage IP addresses, monitor the second network 218, perform services such as authentication, Network Time Protocol [NTP], Dynamic Hosting Configuration Protocol [DHCP], Domain Name Service [DNS] and Exchange services, etc.

In the example of FIG. 2, after passing through the second firewall 216, the first decrypted data 214 is decrypted by the second VPN server 222. As disclosed herein, the second VPN server 222 serves as an inner encryption VPN boundary or gateway prior to permitting access to the secure network 104 where unencrypted data is stored. As a result of further decryption of the first decrypted data 214, the layer of encryption provided by the second VPN tunnel 202 (e.g., the inner VPN tunnel) is removed and data (e.g., plaintext data, unencrypted data) originating at the end device 102 can flow to the secure network 104.

Thus, after the end device 102 is recognized as an authorized device via VPN server authentication methods, the exchange of data can occur between the end device 102 and the secure network 104. The secure network 104 is controlled by a trusted party (e.g., the owner of the secure network 104) and stores unencrypted data. In some examples, the secure network access infrastructure 107 (e.g., a portion of the secure network access infrastructure 107 including the secure network 104) includes a third firewall 226 to provide an additional layer of security after authentication of the end device 102 by the second VPN server 222. The network management service infrastructure components 228 can monitor the secure network 104 and perform services such as authentication, Network Time Protocol [NTP], Dynamic Hosting Configuration Protocol [DHCP], Domain Name Service [DNS] and Exchange services. Also, the example secure network access infrastructure 107 of FIG. 2 (which, in some instances, includes the first network 105 when the first network 105 is a trusted network) can include additional network layers, firewalls, gateways, etc. than shown in FIG. 2.

Data can be transmitted from the secure network 104 to the end device 102 in a reverse of the dataflow process illustrated in FIG. 2. For example, unencrypted data stored at the secure network 104 flows to the second VPN server 222, where the data is encrypted via the second or inner VPN tunnel 202 established between the second VPN server 222 and VPN client circuitry 106 of the end device 102. The encrypted data is encrypted a second time by the first or outer VPN tunnel 200 established between the first VPN server 212 and VPN client circuitry 110 of the mobile hardware VPN device 108. Thus, the data from the secure network 104 is twice encrypted when the data flows through the first (e.g., untrusted) network 105. After passing through the first network 105, the twice-encrypted data is first decrypted by the VPN client circuitry 106 of the end device 102 (e.g., in connection with the inner VPN tunnel 202) to remove the first layer of decryption. The remaining once-encrypted data is then decrypted by the VPN client circuitry 110 of the mobile hardware VPN device 108 (e.g., in connection with the outer VPN tunnel 200) to reveal the unencrypted data from the secure network 104. The unencrypted data is transmitted from the mobile hardware VPN device 108 to the end device 102 (e.g., via the wired connection between the end device 102 and the mobile hardware VPN device 108).

Thus, in the examples of FIGS. 1 and 2, the VPN tunnel 200 established through the mobile hardware VPN device 108 provides an additional layer of data security to enable the end device 102 to access the data stored in the secure network 104. In particular, the VPN tunnel 200 established between the mobile hardware VPN device 108 and the first VPN server 212, in addition to the VPN tunnel 202 established between the end device 102 and the second VPN server 222, permits the end device 102 to access data that otherwise would not be accessible to the end device 102 because of the lack of dual, nested VPN tunnel capability at the end device 102.

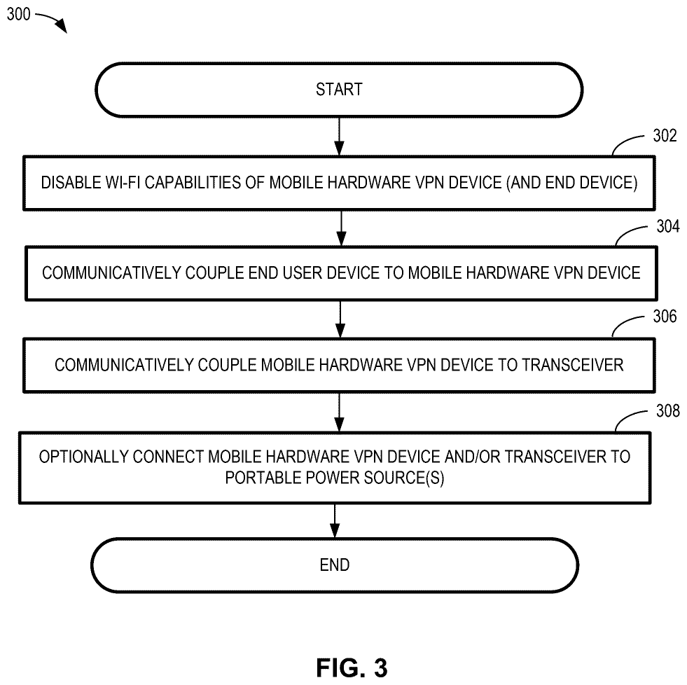

FIG. 3 is a flowchart of an example method 300 for assembling the example system 100 of FIG. 1 to provide dual, nested VPN tunnel capability to an end device. The example method 300 includes disabling Wi-Fi communication capabilities of a mobile hardware VPN device at block 302. For example, the Wi-Fi component(s) 111 (e.g., Wi-Fi antenna(s)) of the mobile hardware VPN device 108 of FIG. 1 may be removed or otherwise disabled from operating (e.g., disabled in BIOS/firmware from operating). In some examples, the Wi-Fi capabilities of the end device 102 are also disabled and/or removed at block 302.

At block 304, the example method 300 includes communicatively coupling an end device to the mobile hardware VPN device. For example, the end device 102 of FIG. 1 can be communicatively coupled to the mobile hardware VPN device 108 via cable(s) extending between one of the I/O port 109 of the end device 102 and one of the network (e.g., LAN) ports 112 of the mobile hardware VPN device 108. The cables can include, for example, an Ethernet cable or a USB-C cable coupled to an Ethernet adapter, which is then coupled to an Ethernet cable. Other types of cable(s) and/or adapters can be used based on the types of ports of the end device 102 (e.g., the TCP/IP supported end device 102) and/or the mobile hardware VPN device 108. As disclosed herein, although the Wi-Fi connection capabilities of the mobile hardware VPN device 108 are disabled and/or removed, the mobile hardware VPN device 108 continues to operate to generate a (second) VPN tunnel in response to detection of the cable received in the network port 112 of the mobile hardware VPN device 108.

The example method 300 of FIG. 3 includes communicatively coupling the mobile hardware VPN device to a transceiver at block 306. For example, the mobile hardware VPN device 108 can be communicatively coupled to the transceiver 114 of FIG. 1 via cable(s) (e.g., e.g., a USB-A to USB-C cable) extending from one of the output ports 116 of the mobile hardware VPN device 108 to one of the input ports 118 of the transceiver 114.

In some examples, the method 300 of FIG. 3 can optionally include connecting portable power source(s) to the mobile hardware VPN device 108 and/or the transceiver 114 at block 308. For example, the portable power source(s) 120 (e.g., one or more portable batteries) can be coupled to the mobile hardware VPN device 108 and/or the transceiver 114 to provide power and portability to the example system 100 of FIG. 1.

Although the example method 300 is described with reference to the flowchart illustrated in FIG. 3, many other methods of assembling a system for providing dual, nested VPN tunnel capability to an end device may alternatively be used. For example, the order of execution of the blocks may be changed, and/or some of the blocks described may be changed, eliminated, or combined. Similarly, additional operations may be included in the example method of FIG. 3 before, in between, or after the blocks shown in FIG. 3.

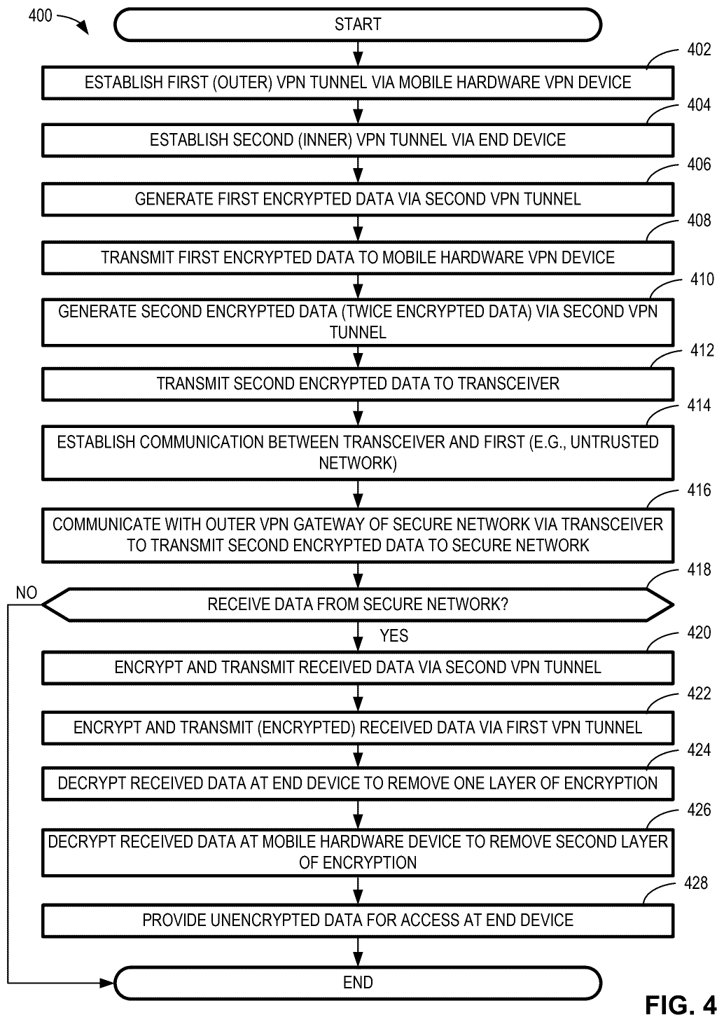

FIG. 4 is a flowchart representative of example machine-readable instructions and/or example operations 400 that may be executed, instantiated, and/or performed by programmable circuitry to provide dual, nested VPN tunnel capability to enable an end device to exchange data with a secure network. The example machine-readable instructions and/or the example operations 400 of FIG. 4 begin at block 402, at which the VPN client circuitry 110 of the example mobile hardware VPN device 108 of FIGS. 1 and 2 establishes a first VPN tunnel 200 (e.g., an outer VPN tunnel) with the first VPN server 212 of the secure network access infrastructure 107 of FIG. 2 (e.g., based on an authentication protocol). At block 404, the VPN client circuitry 106 of the example end device 102 of FIGS. 1 and 2 establishes a second VPN tunnel 202 (e.g., an inner VPN tunnel) with the second VPN server 222 of the secure network access infrastructure 107 of FIG. 2 (e.g., based on an authentication protocol). At block 406, the VPN client circuitry 106 of the end device 102 generates first encrypted data 204 via the second VPN tunnel 202. For example, the VPN client circuitry 106 can encapsulate and encrypt TCP/IP-based data associated with the end device 102.

At block 408, the VPN client circuitry 106 of the end device 102 transmits the first encrypted data 204 to the mobile hardware VPN device 108. At block 410, the VPN client circuitry 110 of the mobile hardware VPN device 108 generates second encrypted data 206 via the second VPN tunnel 202. The second encrypted data 206 can include encryption of the first encrypted data 204 such that the TCP/IP-based data generated by the end device 102 includes two layers of encryption.

At block 412, the VPN client circuitry 110 of the mobile hardware VPN device 108 transmits the second encrypted data 206 to the transceiver 114. At block 414, the transceiver establishes communication with the first (e.g., untrusted) network 105 (e.g., via a wireless communication protocol, such as 3GPP). For example, transceiver 114 establishes communication with the first network 105 as a result of an authentication process. At block 416, the transceiver 114 communicates with the first (outer) VPN server 212 of the secure network access infrastructure 107 to transmit the second encrypted data 206 to the secure network 104.

In some examples, data is sent from the secure network 104 to the end device 102 (block 418). In such examples, at block 420, the data from the secure network 104 is encrypted and transmitted via the second VPN tunnel 202 established between the second VPN server 222 and the VPN client circuitry 106 of the end device 102. At block 422, the data originating at the secure network 104 and encrypted via the second VPN tunnel 202 is encrypted again (i.e., twice encrypted) via the first VPN tunnel 200 established between the first VPN server 212 and the VPN client circuitry 110 of the mobile hardware VPN device 108. At block 424, the twice-encrypted data from the secure network 104 is decrypted by the VPN client circuitry 106 of the end device 102 to remove a layer of encryption. At block 426, the remaining layer of encryption is removed by the VPN client circuitry 110 of the mobile hardware VPN device 108. At block 428, the unencrypted data from the secure network 104 is provided for access at the end device 102 and the example operations 400 end.

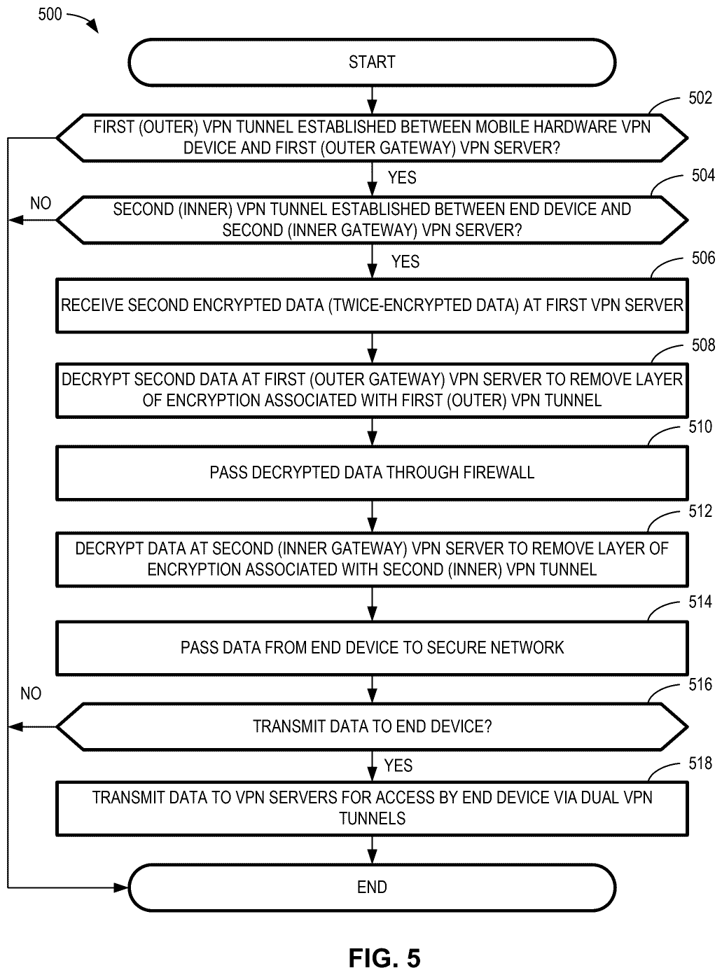

FIG. 5 is a flowchart representative of example machine-readable instructions and/or example operations 500 that may be executed, instantiated, and/or performed by programmable circuitry of a secure network access infrastructure to permit an end device to exchange data with a secure network based on a dual, nested VPN tunnel connection protocol. The example operations 500 of FIG. 5 begin at block 502 at which the first (outer) VPN server 212 of the secure network access infrastructure 107 authenticates the mobile hardware VPN device 108. As a result, the first (outer) VPN tunnel 200 is established between the VPN client circuitry 110 of the mobile hardware VPN device 108 and the first VPN server 212. If the first VPN server 212 does not authenticate the mobile hardware VPN device 108, then no VPN connection is established and the example operations 500 end.

At block 504, the second (inner) VPN server 222 of the secure network access infrastructure 107 authenticates the end device 102. As a result, the second (inner) VPN tunnel 202 is established between the VPN client circuitry 106 of the end device 102 and the second VPN server 222. If the second VPN server 222 does not authenticate the end device 102, then no VPN connection is established and the example operations 500 end.

In examples in which the first and second VPN tunnels 200, 202 are established, then data can be exchanged between the end device 102 and the secure network 104. For example, at block 506, the first (outer) VPN server 212 receives the second encrypted (i.e., twice-encrypted) data 206 associated with the end device (e.g., via transmission of the data by the transceiver 114 of FIG. 1 through the first network 105 via, for example, 3GPP communication protocols). At block 508, the first VPN server 212 decrypts the second encrypted data 206, thereby removing the layer of encryption provided by the first VPN tunnel 200 (e.g., an outer VPN tunnel) associated with the mobile hardware VPN device 108 of FIG. 1. As a result of the decryption at the first VPN server 212, the first decrypted data 214 is generated (i.e., data corresponding to the first or once-encrypted data 204).

At block 510, the first decrypted data 214 passes through a firewall 216 associated with a second network 218 (e.g., a “gray network” per the NSA's CSfC architecture) of the example secure network access infrastructure 107 of FIG. 2. At block 512, the second VPN server 222 (e.g., an inner gateway VPN server) performs further decryption of the first decrypted data 214 to remove the layer of encryption provided by the second VPN tunnel 202 (e.g., an inner VPN tunnel) associated with the end device 102. At block 514, the unencrypted data from the end device 102 passes through the secure network access infrastructure 107 (e.g., the third firewall 226) to the secure network 104 (e.g., a “red network” per the NSA's CSfC architecture) where unencrypted data is stored. In some examples, the secure network 104 transmits data to the end device 102 (block 516). In such examples, at block 518, the data is transmitted to the VPN servers 212, 222 for access by the end device 102 via the dual VPN tunnels 200, 202 and the example operations 500 end.

Example manners of implementing the VPN client circuitry 106 of the end device 102 and the VPN client circuitry 110 of the mobile hardware VPN device 108 are illustrated in FIGS. 1 and 2. The VPN client circuitry 106 and/or the VPN client circuitry 110 can include one or more of elements, processes, and/or devices that may be combined, divided, re-arranged, omitted, eliminated, and/or implemented in any other way. Further, the VPN client circuitry 106 and/or the VPN client circuitry 110 may be implemented by hardware alone or by hardware in combination with software and/or firmware. Thus, for example, the VPN client circuitry 106 and/or the VPN client circuitry 110 could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example the VPN client circuitry 106 of the end device 102 and/or the VPN client circuitry 110 of the mobile hardware VPN device 108 may include one or more elements, processes, and/or devices in addition to, or instead of, those illustrated in FIGS. 1 and 2, and/or may include more than one of any or all of the illustrated elements, processes and devices.

The VPN client circuitry 106 of the end device 102 and/or the VPN client circuitry 110 of the mobile hardware VPN device 108 and/or respective components thereof may be instantiated (e.g., creating an instance of, bring into being for any length of time, materialize, implement, etc.) by programmable circuitry such as a Central Processor Unit (CPU) executing first instructions. Additionally or alternatively, the VPN client circuitry 106 of the end device 102 and/or the VPN client circuitry 110 of the mobile hardware VPN device 108 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIGS. 1 and 2 may be implemented by microprocessor circuitry executing instructions and/or FPGA circuitry performing operations to implement one or more virtual machines and/or containers.

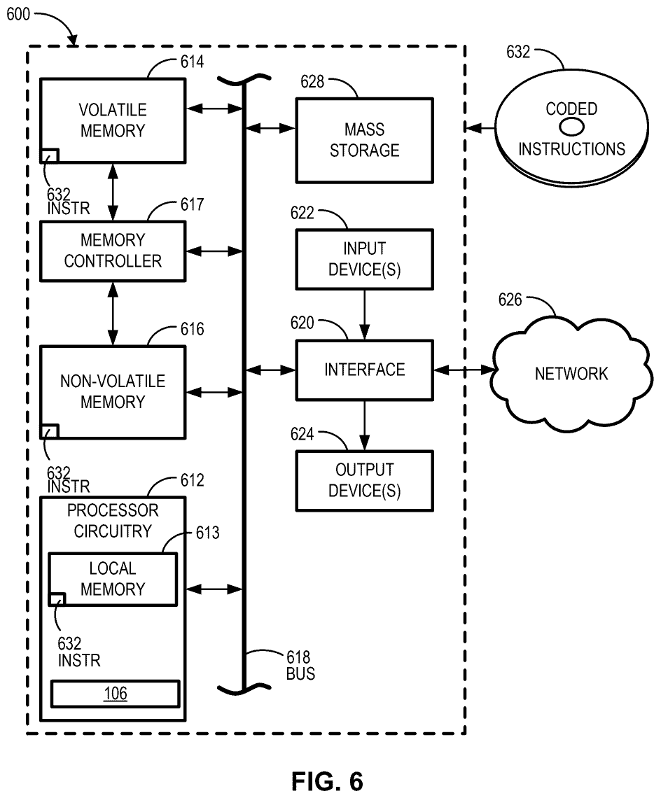

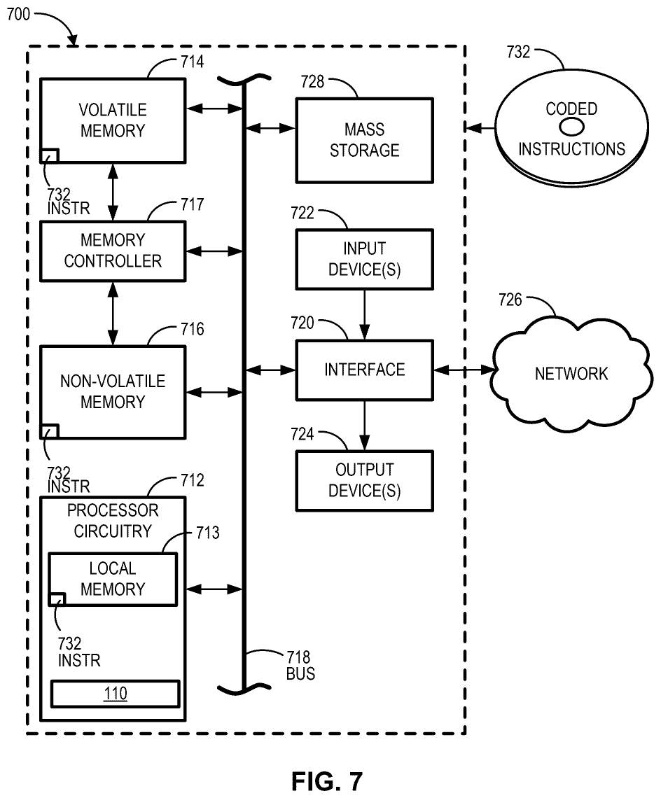

The flowchart of FIG. 4 is representative of example machine-readable instructions, which may be executed by programmable circuitry to implement and/or instantiate the VPN client circuitry 106 of the end device 102 and the VPN client circuitry 110 of the mobile hardware VPN device 108 and/or representative of example operations which may be performed by programmable circuitry to implement and/or instantiate the VPN client circuitry 106 of the end device 102 and the VPN client circuitry 110 of the mobile hardware VPN device 108. The machine-readable instructions may be one or more executable programs or portion(s) of one or more executable programs for execution by programmable circuitry such as the programmable circuitry 612, 712 shown in the example programmable circuitry platform 600, 700 discussed below in connection with FIGS. 6 and 7. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIG. 4, many other methods of implementing the example VPN client circuitry 106 of the end device 102 and/or the VPN client circuitry 110 of the mobile hardware VPN device 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable, computer readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 4 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 6 is a block diagram of an example programmable circuitry platform 600 structured to execute and/or instantiate the example machine-readable instructions and/or the example operations of FIG. 4 (e.g., blocks 402, 404, 406, 418, 420 of FIG. 4) to implement the VPN client circuitry 106 of the end device 102 of FIG. 1. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the VPN client circuitry 106.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 632, which may be implemented by the machine-readable instructions of FIG. 4 (e.g., blocks 402, 404, 406, 418, 420), may be stored in the mass storage device 628, in the volatile memory 614, in the non-volatile memory 616, and/or on at least one non-transitory computer-readable storage medium such as a CD or DVD which may be removable.

FIG. 7 is a block diagram of an example programmable circuitry platform 700 structured to execute and/or instantiate the example machine-readable instructions and/or the example operations of FIG. 4 (e.g., blocks 408, 410, 412, 418) to implement the VPN client circuitry 110 of the mobile hardware VPN device 108 of FIGS. 1 and 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the VPN client circuitry 110.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 732, which may be implemented by the machine-readable instructions of FIG. 4 (e.g., blocks 408, 410, 412, 418 of FIG. 4), may be stored in the mass storage device 728, in the volatile memory 714, in the non-volatile memory 716, and/or on at least one non-transitory computer-readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide an end device with dual VPN tunnel capability to enable connectivity between the end device and a secure network for the exchange of data. Examples disclosed herein can be used to facilitate authentication of an end device that supports one VPN tunnel by generating a second VPN tunnel via a mobile hardware VPN device. As a result, examples disclosed herein enable the end device to satisfy authentication protocols that are based on the use of dual, nested VPN tunnels. Further, examples disclosed can be used in environments in which Wi-Fi communication is not permitted due to security concerns. Examples disclosed herein use mobile devices (e.g., a mobile hardware VPN device, a portable battery) for portable access to secure networks in different environments using dual VPN tunnel protocols.

Example systems, apparatus, and methods to provide dual virtual private network connectivity are disclosed herein. Further examples and combinations thereof include the following:

Example 1 includes a system comprising a mobile hardware virtual private network (VPN) device, the mobile hardware VPN device communicatively coupled to an end device, the mobile hardware VPN device to establish a first VPN tunnel to encrypt data generated by a second VPN tunnel associated with the end device; and a transceiver communicatively coupled to the mobile hardware VPN device, the transceiver to communicate with a secure network via a wireless communication protocol to cause a VPN server to permit the end device to exchange data with the secure network via the first VPN tunnel and the second VPN tunnel.

Example 2 includes the system of example 1, wherein the mobile hardware VPN device is communicatively coupled to the end device via a cable received in a network port of the mobile hardware VPN device.

Example 3 includes the system of examples 1 or 2, wherein a Wi-Fi antenna of the mobile hardware VPN device is disabled.

Example 4 includes the system of any of examples 1-3, wherein the communicative coupling between the mobile hardware VPN device and the transceiver is a wired communicative coupling.

Example 5 includes the system of any of examples 1-4, wherein the wireless communication protocol is a 5G communication protocol.

Example 6 includes the system of any of examples 1-5, further including a portable battery coupled to one or more of the mobile hardware VPN device or the transceiver.

Example 7 includes the system of any of examples 1-6, wherein the data encrypted by the first VPN tunnel includes Internet Protocol-based data.

Example 8 includes a method comprising communicatively coupling an end device to a mobile hardware virtual private network (VPN) device; and communicatively coupling the mobile hardware VPN device to a wireless communication-based transceiver to enable communication between the end device and a secure network based on a wireless communication protocol.

Example 9 includes the method of example 8, further including disabling a Wi-Fi antenna of the mobile hardware VPN device.

Example 10 includes the method of examples 8 or 9, wherein communicatively coupling the end device to the mobile hardware VPN device includes coupling one or more cables between an output port of the end device and an input port the mobile hardware VPN device, the input port of the mobile hardware VPN device corresponding to an ethernet port.

Example 11 includes the method of any of examples 8-10, wherein communicatively coupling the mobile hardware VPN device to the transceiver includes coupling one or more cables between an output port of the mobile hardware VPN device and an input port of the transceiver.

Example 12 includes the method of any of examples 8-11, further including coupling one or more of the mobile hardware VPN device or the transceiver to a portable power source.

Example 13 includes the method of any of examples 8-12, further including disabling a Wi-Fi antenna of the end device.

Example 14 includes a method comprising generating, via an end device, first encrypted data via a first virtual private network (VPN) tunnel; generating, via a mobile hardware VPN device, second encrypted data via a second VPN tunnel, the second encrypted data including the first encrypted data; transmitting the second encrypted data to a transceiver; and transmitting, by the transceiver and via a wireless communication protocol, the second encrypted data to a secure network for decryption of the first encrypted data and the second encrypted data.

Example 15 includes the method of example 14, wherein transmitting the second encrypted data to the transceiver includes transmitting the second encrypted data via wired connection between the mobile hardware VPN device and the transceiver.

Example 16 includes the method of examples 14 or 15, further including transmitting the first encrypted data from the end device to the mobile hardware VPN device via wired connection between the end device and a network port of the mobile hardware VPN device.

Example 17 includes the method of any of examples 14-16, further including receiving, at the end device, via the first VPN tunnel and the second VPN tunnel, data from the secure network.

Example 18 includes the method of any of examples 14-17, further including communicating, via the transceiver, with an untrusted network to transmit the second encrypted data.

Example 19 includes the method of any of examples 14-18, wherein the second VPN tunnel is an Internet Protocol Security (IPSec) Internet Key Exchange (IKE) VPN tunnel.

Example 20 includes the method of any of examples 14-19, wherein the first encrypted data includes Internet Protocol-based data.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system comprising:
a mobile hardware virtual private network (VPN) device, the mobile hardware VPN device communicatively coupled to an end device, the mobile hardware VPN device to establish a first VPN tunnel to encrypt data generated by a second VPN tunnel associated with the end device; and
a transceiver communicatively coupled to the mobile hardware VPN device, the transceiver to communicate with a secure network via a wireless communication protocol to cause a VPN server to permit the end device to exchange data with the secure network via the first VPN tunnel and the second VPN tunnel.

2. The system of claim 1, wherein the mobile hardware VPN device is communicatively coupled to the end device via a cable received in a network port of the mobile hardware VPN device.

3. The system of claim 2, wherein a Wi-Fi antenna of the mobile hardware VPN device is disabled.

4. The system of claim 1, wherein the communicative coupling between the mobile hardware VPN device and the transceiver is a wired communicative coupling.

5. The system of claim 1, wherein the wireless communication protocol is a 5G communication protocol.

6. The system of claim 1, further including a portable battery coupled to one or more of the mobile hardware VPN device or the transceiver.

7. The system of claim 1, wherein the data encrypted by the first VPN tunnel includes Internet Protocol-based data.

8. A method comprising:
communicatively coupling an end device to a mobile hardware virtual private network (VPN) device; and
communicatively coupling the mobile hardware VPN device to a wireless communication-based transceiver to enable communication between the end device and a secure network based on a wireless communication protocol.

9. The method of claim 8, further including disabling a Wi-Fi antenna of the mobile hardware VPN device.

10. The method of claim 8, wherein communicatively coupling the end device to the mobile hardware VPN device includes coupling one or more cables between an output port of the end device and an input port the mobile hardware VPN device, the input port of the mobile hardware VPN device corresponding to an ethernet port.

11. The method of claim 8, wherein communicatively coupling the mobile hardware VPN device to the transceiver includes coupling one or more cables between an output port of the mobile hardware VPN device and an input port of the transceiver.

12. The method of claim 8, further including coupling one or more of the mobile hardware VPN device or the transceiver to a portable power source.

13. The method of claim 8, further including disabling a Wi-Fi antenna of the end device.

14. A method comprising:
generating, via an end device, first encrypted data via a first virtual private network (VPN) tunnel;
generating, via a mobile hardware VPN device, second encrypted data via a second VPN tunnel, the second encrypted data including the first encrypted data;
transmitting the second encrypted data to a transceiver; and
transmitting, by the transceiver and via a wireless communication protocol, the second encrypted data to a secure network for decryption of the first encrypted data and the second encrypted data.

15. The method of claim 14, wherein transmitting the second encrypted data to the transceiver includes transmitting the second encrypted data via wired connection between the mobile hardware VPN device and the transceiver.

16. The method of claim 14, further including transmitting the first encrypted data from the end device to the mobile hardware VPN device via wired connection between the end device and a network port of the mobile hardware VPN device.

17. The method of claim 14, further including receiving, at the end device, via the first VPN tunnel and the second VPN tunnel, data from the secure network.

18. The method of claim 14, further including communicating, via the transceiver, with an untrusted network to transmit the second encrypted data.

19. The method of claim 14, wherein the second VPN tunnel is an Internet Protocol Security (IPSec) Internet Key Exchange (IKE) VPN tunnel.

20. The method of claim 14, wherein the first encrypted data includes Internet Protocol-based data.
